(19) United States
(12) Patent Application Publication
(10) Pub. No.: US 2026/0220979 A1
(43) Pub. Date: Jul. 30, 2026

(54) SMART COMPACT GADGET FOR CARS

(71) Applicant: Fatemeh SHARIFIOUN, Tehran (IR)

(72) Inventor: Fatemeh SHARIFIOUN, Tehran (IR)

(21) Appl. No.: 19/148,607

(22) PCT Filed: Jan. 30, 2023
(86) PCT No.: PCT/IB2023/050768

§ 371 Date: Jul. 16, 2025

(51) Int. Cl. G07C 5/00

(52) U.S. Cl. CPC G07C 5/008

(57) ABSTRACT

If the car has been hit, and if there were any other conditions, other lights would turn on according to the circumstances. For instance, if your car catches fire for any reason, your device will notify you instantly. Moreover, this innovation will call the authorities such as the fire department, the insurance company, the police, etc. Also, when the insurance agent is assessing the damage done to your car, you can get a report of the accident and give it to the agent.

### TECHNICAL FIELD

The field of this invention relates to car event recording using car sensors so that it can store real-time information in its memory automatically

### BACKGROUND ART

In recent years, there have been substantial advances in recording car events on internal memory, burglar alarms remote control, and speedometers connected to the tracking systems, but until today, there is no single device that has all these features and can send this information from its central core instantly to the car owner and interested organizations.

### Technical Problem

One of the main things that bug the people who own a car is whether they are not sure if their car is safe or not. For instance, there wasn't any parking space near your own house, and you had to park your car one block away. If your car were one of the things you hold dear, you would always be worried about your vehicle. This problem is very common in crowded cities such as Tehran, New York, Dehli, etc.

Therefore, we came up with this smart innovation that helps people by notifying them of any kind of impact that comes upon the car

Because of the lack of precise information about car accidents and the difficult calculation of claimed damage, insurance companies receive very high insurance premiums from car owners. This has caused complaints among drivers, and on the other hand, insurance companies present fraud as a justification for claiming more damages from the insurance company. This invention by recording events in all situations, both in stopped or moving states, makes it possible for the loss assessor to determine the damage after the accident, which prevents the occurrence of fraud through careful assessment. In this case, the need to increase insurance premiums to offset is obviated.

### Solution to Problem

If the car has been hit, and if there were any other conditions, other lights would turn on according to the circumstances. For instance, if your car catches fire for any reason, your device will notify you instantly. Moreover, this innovation will call the authorities such as the fire department, the insurance company, the police, etc. Also, when the insurance agent is assessing the damage done to your car, you can get a report of the accident and give it to the agent.

This smart device has the shape of your car but in the dimensions of a business card. Also, this innovation weighs about 300 grams with a thickness of 7 millimeters. Accordingly, it will not take much space. Moreover to the color LCD, this innovative car alarm has 4 LED lights that demonstrate four conditions, such as the alarm being on or off, fire, impact, and hazard lights.

All these lights let you know if the car has been hit, and if there were any other conditions, other lights would turn on according to the circumstances.

It is possible to send events such as shock, fire, theft, speed, accident, and any related information from the ECU to the central system by adding sensors to the car and connecting them to the ECU so that after every incident, a message is sent to the car owner and the related organization with detailed information about the incident along with the time and place of the incident. This message can be in the form of SMS, email, notification, etc.

### Advantageous Effects of Invention

1—Instant sending of information to the central core and storage on the external data center
2—Integration of event recording and burglar alarm accessories
3—Recording events such as fire, shock, theft, and accident in an integrated manner
4—Sending events to the car owner and interested organizations

### BRIEF DESCRIPTION OF DRAWINGS

FIG. 1: Device in different view

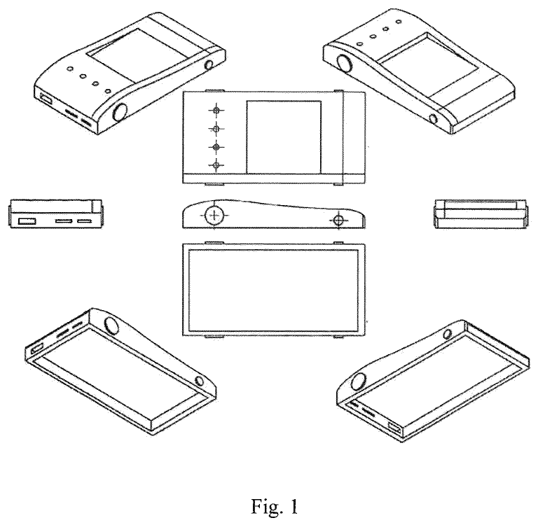

### EXAMPLES

The method for using this invention is such that when the shock and temperature sensors are embedded in specific places next to the speedometer sensor of the car, the consolidated and integrated information will be stored in repetitive time intervals and the central core and this information will be available for the investigation of the events.

### INDUSTRIAL APPLICABILITY

### Application of the Invention

1—Sending the instant and real-time status of the car for its owner
2—Existence of event data for use in claim files
3—Burglar alarm

1. Gadget for car comprising:
a. sensors which added to ECU
send events such as shock, fire, theft, speed, accident, and information from the ECU to the central system by adding sensors to the car and connecting them to the ECU so that after every incident, a message is sent to the car owner and the related organization with detailed information about the incident along with the time and place of the incident.
